(19) United States
(12) Patent Application Publication
(10) Pub. No.: US 2017/0144848 A1
(43) Pub. Date: May 25, 2017

(54) DUST COLLECTION SYSTEMS AND METHODS FOR USE WITH MATERIAL DELIVERY SYSTEMS

(71) Applicant: BAKER HUGHES INCORPORATED, Houston, TX (US)

(72) Inventors: Roger A Koehler, Houston, TX (US); Jay D. Jordan, College Station, TX (US); Bryan Scott Lambert, The Woodlands, TX (US)

(21) Appl. No.: 15/322,029

(22) PCT Filed: Jun. 11, 2015
(86) PCT No.: PCT/US2015/035304

§ 371 Date: Dec. 23, 2016

Related U.S. Application Data
(60) Provisional application No. 62/017,971, filed on Jun. 27, 2014.

(51) Int. Cl. B65G 69/18; E21B 41/00

(52) U.S. Cl. CPC B65G 69/182; E21B 41/00; E21B 43/267

(57) ABSTRACT

System (10) for containing airborne dust created during the transfer of material between components of a material delivery system (18) includes at least one airflow duct (70) fluidly coupled to at least one central vacuum unit (14) and configured to direct at least some of the contained airborne dust to the central vacuum unit.

### CROSS REFERENCE TO RELATED APPLICATIONS

The present application claims priority to U.S. Provisional Patent Application Ser. No. 62/017,971, filed on Jun. 27, 2014 and entitled “Dust Collection System and Methods for Use with Material Delivery Systems”, which is hereby incorporated herein in its entirety.

### FIELD OF THE INVENTION

The present disclosure relates generally to collecting dust created in or around material storage, delivery and/or conveyance equipment.

### BACKGROUND OF THE INVENTION

Various industries involve the delivery, handling and transfer of materials, such as dry solids. One common problem often encountered in using such systems is the creation of dust that includes particles (or conglomerates of particles) of the material and dispersement of such dust into the ambient air or atmosphere. This can lead to potential health and safety concerns for on-site personnel and potential environmental problems, depending upon the type of material. The creation of dust can also clog, bind or damage equipment, such as air filters, radiators, etc. and lead to early down time, maintenance and failure.

In on-site hydraulic fracturing operations, for example, the dry solids in the form of proppant is often delivered into one or more material storage/dispensing unit, and from that unit to one or a series of other items of equipment, such as a dual-belt device and blender unit. Dust is often created and dispersed into the ambient air when the proppant is loaded into the dispensing unit and/or transferred between equipment items and/or by wind blowing through or around such equipment. Presently known systems for containing such dust have various disadvantages. For example, some present systems are cumbersome, ineffective and time consuming to assemble and disassemble. Thus, it would advantageous to be able to efficiently and effectively contain dust created during these processes to prevent it from entering the ambient air.

It should be understood that the above-described features and examples are provided for illustrative purposes only and are not intended to limit the scope or subject matter of the appended claims or those of any related patent application or patent. None of the appended claims or claims of any related application or patent should be limited by the above discussion or construed to address, include or exclude each or any of the cited examples, features and/or disadvantages, merely because of the mention thereof herein.

Accordingly, there exists a need for improved systems, apparatus and methods useful to assist in containing dust created in connection with material storage, delivery and/or conveyance systems having one or more of the attributes or capabilities described or shown in, or as may be apparent from, the other portions of this patent.

### BRIEF SUMMARY OF THE DISCLOSURE

In some embodiments, the present disclosure involves systems for containing airborne dust created during the transfer of material between components of a material delivery system with the use of at least one central vacuum unit that provides vacuum suction pressure to the dust containment system. The material delivery system includes at least one material dispenser, material transfer unit and material receiving unit. The material dispenser has at least on material storage compartment and at least one material discharge point. The material transfer unit has at least one material conveyor, and the material receiving unit has at least one material receiving point. Material is loaded into the material storage compartment of the material dispenser and thereafter discharged from the material dispenser at the discharge point onto the conveyor of the material transfer unit and therefrom to the material receiving point of the material receiving unit. The air containment system includes a first air restriction cover encapsulating each material discharge point sufficient to contain airborne dust created when material is discharged to the material transfer unit at the discharge point and prevent such dust from escaping into the ambient air. A second air restriction cover encapsulates each material receiving point sufficient to contain airborne dust created when material is received at the material receiving point from the material transfer unit and prevent such dust from escaping into the ambient air. At least one airflow duct is mounted upon the material transfer unit, fluidly coupled to the air restriction covers and central vacuum unit and configured to draw in air and dust contained in the first and second air restriction covers and direct it to the central vacuum unit. At least one other airflow duct is disposed within the material dispenser, fluidly coupled to at least one material storage compartment therein and at least one central vacuum unit and configured to draw in airborne dust created in the material storage compartment when material is loaded therein and direct it to the central vacuum unit.

In various embodiments, the present disclosure involves a system for containing airborne dust created during the transfer of proppant between a hydraulic fracturing sand-conveying unit, dual-belt device and frac blender with the use of at least one central vacuum unit that provides vacuum suction pressure to the system. The sand-conveying unit includes multiple material storage compartments and the dual-belt device material transfer unit has at least one material conveyor. Proppant is loaded into the material storage compartments of the sand-conveying unit, and thereafter discharged onto the conveyor of the dual-belt device and therefrom to the frac blender. At least a first airflow duct is mounted upon the dual-belt device and is fluidly coupled to at least one central vacuum unit. At least a second airflow duct is disposed within and extends at least partially through the length of the sand-conveying unit. The second airflow duct is fluidly coupled to each material storage compartment therein and the first airflow duct. The second airflow duct is configured to draw in airborne dust created in the material storage compartments when proppant is loaded therein and direct it to the first airflow duct and ultimately to the central vacuum unit. The second airflow duct is configured so that air velocities remain substantially constant throughout the length thereof during use of the system.

Accordingly, the present disclosure includes features and advantages which are believed to enable it to advance material storage, delivery and/or conveyance technology. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is schematic view of an embodiment of a dust containment system of the present disclosure shown used with an exemplary material delivery system and central vacuum unit;

FIG. 2 is a side view of portions of the exemplary dust containment system and material delivery system represented in FIG. 1; and

FIG. 3 is a perspective view of portions of the exemplary dust containment system and material delivery system represented in FIG. 1.

### DETAILED DESCRIPTION OF PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and described preferred embodiments in the appended figures, common or similar elements are referenced with like or identical reference numerals or are apparent from the figures and/or the description herein. The figures are not necessarily to scale and certain features and certain views of the figures may be shown exaggerated in scale or in schematic in the interest of clarity and conciseness.

As used herein and throughout various portions (and headings) of this patent application, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

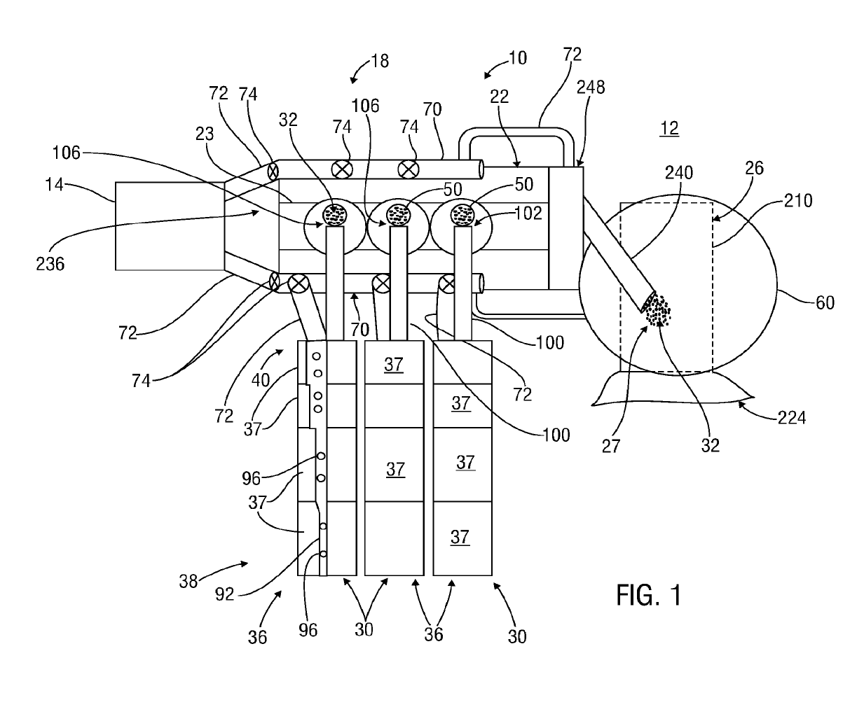

Referring to FIG. 1, an embodiment of a dust containment system 10 useful for collecting free-flying, or airborne, dust created during the transfer of material 32 into or between components of a material delivery system 18 is shown. The material delivery system 18 may have any suitable components, configuration and operation. The illustrated material delivery system 18 includes at least one material dispenser 30, material transfer unit 22 and material receiving unit 26, and is shown along with at least one conventional central vacuum unit 14. The central vacuum unit 14 fluidly couples to the dust containment system 10 and operates as is and becomes further known to create vacuum suction pressure that pulls, or draws, air (and dust contained therein) from the dust containment system 10. The terms “vacuum-pressurized” and variations thereof as used herein means being capable of having a vacuum pulled or drawn thereupon. Thus, the illustrated system 10 is vacuum-pressurized.

Each exemplary material dispenser 30 includes at least one internal material storage compartment 37 and at least one material discharge point 106. The illustrated material transfer unit 22 includes at least one material conveyor 23, while the material receiving unit 26 includes at least one material receiving point 27. In this example, material 32 is loaded into each material storage compartment(s) 37 of each material dispenser 30 and thereafter discharged therefrom at the discharge point(s) 106 onto the conveyor(s) 23 of the material transfer unit(s) 22, and therefrom to the material receiving point(s) 27 of the material receiving unit(s) 26. Free-flying particles of the transferred material 32, referred to herein as “dust”, may be generated, or discharged into the air, during each recited phase. The dust containment system 10 of the present disclosure is useful to capture or contain some or substantially all, of such airborne dust. As used herein, the term “substantially” and variations thereof includes “all” and lesser amounts up to 95% of all, or the desired amount, of the referenced variable, element or limit.

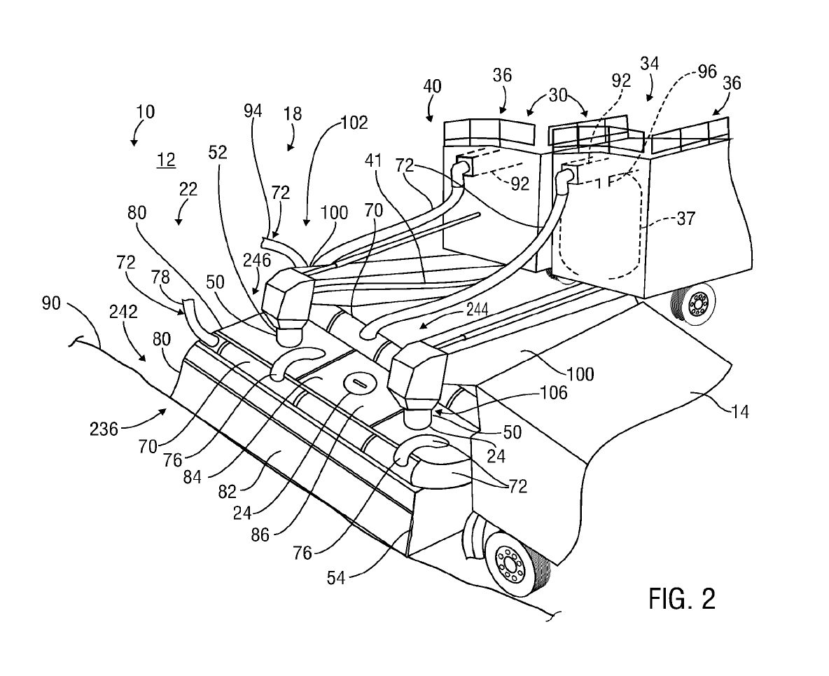

The material 32 may be any type of solids, or solid-liquid combination that can be moved between components and which includes individual particles (or conglomerates of particles) that can float in the air. Some examples of materials 32 are dry solids, sand, proppant and dry additives, such as soy gum. The material dispenser(s) 30, material transfer unit(s) 22 and material receiving unit(s) 26 may have any suitable form, configuration and operation useful to handle or deliver the material 32. An example material dispenser 30 is a hydraulic fracturing sand-conveying unit 36 used on-site at drilling locations in the oilfield industry, such as the Frac Sander by National Oilwell Appco. A typical mobile sand conveying unit 36 includes multiple (e.g. four) material storage compartments 37 into which the material 32 is loaded from above and from which the material 32 is dispensed onto one or more conveyor belt 41 (FIG. 2) located below the compartments 37. In this example, as shown in FIG. 2, the conveyor belt 41 runs across a stinger 100 extending from the rear end 40 of the material dispenser 30, and discharges the material from material dispenser 30 at a material discharge point 106 at the far end 102 of the stinger 100. In this example, the “discharge point” is at the end 102 of the stinger 100, but could be at any other locations of, or areas on, the stinger 100 or conveyor belt 41 from which the material 32 can be discharged, removed or otherwise delivered, or of any other desired component and location on the material dispenser 30. Some other examples of material dispensers 30 are horizontal and vertical sand silos, hopper systems or other equipment useful for discharging material 32, and may be non-mobile or mounted on trailers or vehicles, stimulation vessels or other off-shore equipment.

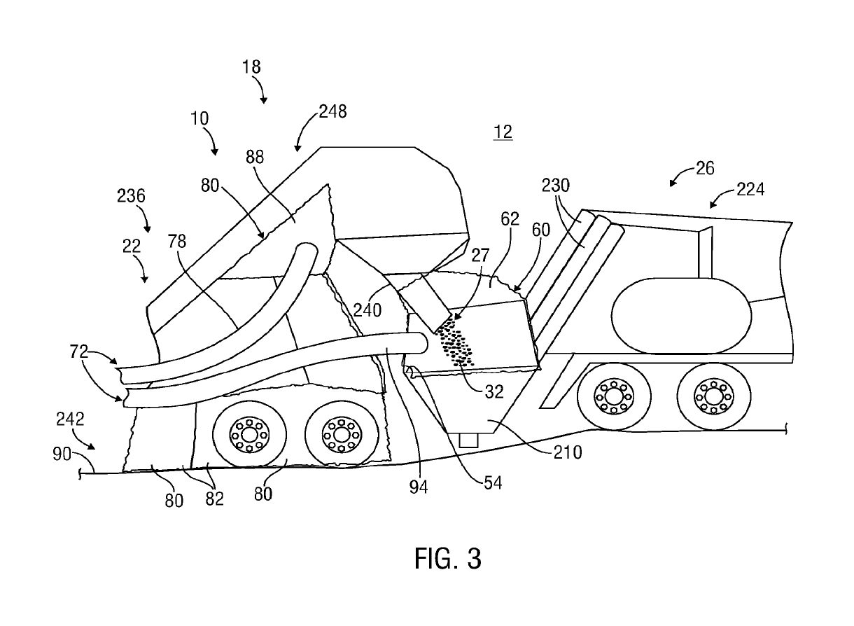

Still referring to FIG. 1, an example material transfer unit(s) 22 is a mobile dual-belt device 236, which typically receives the material 32 from the material dispenser 30 and delivers it to the material receiving unit 26. Typical dual-belt devices 236 include at last one elongated material conveyor 23 configured to receive material 32 substantially concurrently from numerous material dispensers 30. For example, the dual-belt device 236 may be configured to receive material 32 from up to five mobile sand conveying or storage units 36 parked along its sides on an ongoing basis. The exemplary dual-belt device 236 delivers the material 32 through one or more delivery chute 240 to one or more blender unit 224. In the illustrated example, the delivery chute 240 extends from a vertical portion 248 of the dual-belt device 236 (see also FIG. 3).

Still referring to FIG. 1, an example material receiving unit 26 is a mobile frac blender unit 224. The exemplary blender unit 224 is useful for mixing the material 32, such as sand or proppant, in pre-determined proportions with one or more liquid and/or chemical and feeding the mixture to one or more fracturing fluid pumping units (not shown), which delivers the mixture into an underground well (not shown) under high pressure on a continuing basis. In this example, the material receiving point 27 is a bin 210 mounted on the blender unit 224. The exemplary bin 210 includes at least one flow outlet (not shown) aligned with a passageway (sometimes referred to as a “screw”) 230 (FIG. 3) of the blender unit 224. Material 32 in the exemplary bin 210 is sucked, or drawn, upwardly from the flow outlet(s) through one or more of the screws 230 into a mixing tub (not shown) of the blender unit 224.

The dual-belt device 236 may, for example, be mounted on a trailer that is parked, or positionable, among various locations and orientations relative to the blender unit 224 to provide material 32 into the bin 210. In a typical hydraulic fracturing job, the delivery of material 32 from the material dispenser 30 to the dual-belt device 236 to the blender unit 224 to the fracturing fluid pumping units (not shown) occurs on an ongoing basis over one or more time period.

Additional details about the form, configuration and operation of the illustrated and other types of material dispensers 30, material transfer units 22 and material receiving units 26, or other components of a material delivery system 18, are known in the art and may be found in publicly available documents. However, the present disclosure is not limited by any of above or other details about the type, form, configuration and operation of the material delivery system 18, central vacuum unit 14 or any components thereof. Accordingly, the dust containment system 10 of the present disclosure may be used with any suitable material delivery system 18 and central vacuum unit 14.

Referring again to FIG. 1, the dust containment system 10 of the present embodiment includes at least a first air restriction cover 50 encapsulating each material discharge point 106 sufficient to contain dust created when material 32 is discharged at the discharge point 106 to the material transfer unit 22 and prevent such dust from entering, or escaping, into the ambient air 12 (see also FIG. 2). As used herein, the terms “ambient air” and variations thereof refers to air outside the dust containment system 10. In this embodiment, a second air restriction cover 60 (see also FIG. 3) encapsulates each material receiving point 27 at the material receiving unit 26 sufficient to contain dust created when material is received at the material receiving point 27 from the material transfer unit 22 and prevent such dust from entering, or escaping, into the ambient air 12. The covers 50, 60 may also, depending upon the circumstances, prevent the creation of dust by wind blowing in their vicinity. The exemplary system 10 also includes at least a first vacuum-pressurized airflow duct 70 fluidly coupling the air restriction covers 50, 60 to at least one central vacuum unit 14. The exemplary duct 70 is configured to draw in and capture dust contained in the covers 50, 60 and direct it to the vacuum unit 14. As used herein, the term “duct” and variations thereof means a single segment or multiple interconnected segments of ductwork, tubing, piping or any other suitable component or apparatus having at least one air flow passageway therein.

Still referring to FIG. 1, the air restriction covers 50, 60 and airflow duct 70 may have any suitable construction, form, configuration and operation. For example, the airflow duct 70 may be a conventional, commercially available, tube-shaped air duct having one or more particular internal diameter that allows the desired air flow velocity and/or volume between the covers 50, 60 (and any other connected components) and the central vacuum unit 14, or through the system 10. The duct(s) 70 may, if desired, be permanently, or semi-permanently, mounted upon the material transfer unit 22. As used herein, the terms semi-permanently and variations thereof means being selectively removable, such as for repair, replacement, maintenance, etc. In the illustrated example, as shown in FIG. 2, the system 10 includes two airflow ducts 70 mounted on and extending along the top of opposite sides 242, 244 of the dual-belt device 236, each connected to the central vacuum unit 14.

In FIG. 2, the air restriction cover 50 is, for example, a sheath 52 secured around the end 102 of the stinger 100 and over a corresponding access opening 24 to the dual-belt device 236. The illustrated sheath 52 is funnel or tube-shaped, but may have any other suitable shape and orientation. As shown in FIG. 3, the air restriction cover 60 may, for example, be a tent-like sheath 62 secured around the end of the delivery chute 240 of the dual-belt device 236 and over the bin 210 of the blender unit 224, but may have any other suitable shape and orientation. The covers 50, 60 may be secured to the adjacent components in any suitable manner, such as with wire, cord, tape, velcro, mechanical connectors (e.g. fastening rings), chemicals (e.g. epoxy), or a combination thereof. If desired, the covers 50, 60 may be permanently, or semi-permanently, mounted upon either of the respective corresponding adjacent components, or partially upon both respective corresponding components (such as a cover 50, 60 that has two parts that mate or snap together).

The covers 50, 60 may be substantially sealingly engaged to their adjacent components, so long as the system 10 is vacuum-pressurized as desired. In this embodiment, one or more selectively sized and positioned air inlet openings 54 (e.g. FIGS. 2 & 3) are provided in the covers 50, 60 or adjacent thereto, such as to allow sufficient ambient air flow into the cover 50, 60 to facilitate the desired air flow and vacuum pressurization in the system 10. In some embodiments, the covers 50, 60 may be air-tight.

If desired, the system 10 may include one or more additional components for preventing the discharge of dust into the ambient air 12 from the material delivery system 18. In FIG. 2, for example, at least a third air restriction cover 80 at least substantially surrounds the material conveyor(s) 23 (FIG. 1) of the material transfer unit 22 and is fluidly coupled to at least one airflow duct 70. The air restriction cover(s) 80 may have any suitable construction, form, configuration and operation sufficient to contain dust created in or around the material transfer unit 22 and prevent such dust from entering, or escaping, into the ambient air 12. Depending upon the circumstances, the cover(s) 80 may also prevent the creation of dust by wind blowing in their vicinity. If desired, the cover(s) 80 may be permanently, or semi-permanently, mounted upon the material transfer unit 22.

In this example, the cover 80 includes a curtain 82 that extends down along each side (and end) of the dual-belt device 236, such as to contain dust created around the conveyor(s) 23 (FIG. 1) and/or block the creation of dust by wind blowing around the conveyor 23 (FIG. 1) or though the device 236. For example, the curtain 82 may be a flexible sheet that drops down to, or near, the ground 90 and which can be rolled up during non-use or transportation of the dual-belt device 236.

Still referring to FIG. 2, another example of an air restriction cover(s) 80 that may also, or instead, be included with the system 10 is one or more lid 84 extending at least partially across the top 246 of the dual-belt device 236. In this example, the lid 84 includes a series of metallic plates 86 positioned across the top 246 over the material conveyor 23 (FIG. 1). The exemplary lid 84 has access openings 24 formed therein to allow the delivery of material 32 to the material conveyor 23 (FIG. 1) from the material dispenser(s) 30. Yet another example of an air restriction cover(s) 80 that may also, or instead, be included with the system 10 is one or more sheath 88 (FIG. 3) positioned adjacent to the vertical portion 248 of the dual-belt device 236. The exemplary sheath 88 covers one or more opening in or adjacent to the vertical portion 248. Each cover 80 may or may not be substantially sealingly engaged to its adjacent components, so long as the system 10 is sufficiently vacuum-pressurized as desired. In this embodiment, one or more selectively sized and positioned air inlet openings 54 (FIG. 3) are provided in the cover 80 or adjacent thereto, such as to allow sufficient ambient air flow into the cover 80 to facilitate the desired air flow and vacuum pressurization in the system 10. In some embodiments, the cover(s) 80 may be air-tight.

The air restriction covers 50, 60, 80 may be constructed of any suitable material. The material used for each cover 50, 60, 80 may depend upon its particular disposition in the system 10. For example, one or more of the covers 80 (e.g. sheaths 52, 62, 88 and curtains 82) may include flexible material, such as canvas, plastic or rubber, while other of the covers 80 (e.g. lid 84) may include rigid material, such as steel or aluminum.

The duct(s) 70 may be fluidly coupled to the covers 50, 60, 80 and central vacuum unit 14 in any suitable manner. In this embodiment, as shown in FIGS. 1-3, one or more respective connection hoses, or ducts, 72 may be used between the duct(s) 70 and the vacuum unit 14 and one or more covers 50, 60, 80. The connection hose 72 may have any suitable form, configuration and operation. For example, the hose 72 may be a conventional, commercially available flexible hose having a size that allows the desired air flow velocity and/or volume through the system 10 and to the central vacuum unit 14.

In some embodiments, other portions of the material dispenser 30 may be at least partially enclosed with, or surrounded by, one or more air restriction cover (not shown) to assist in preventing the discharge of dust into the ambient air 12 therefrom. For example, in the embodiment of FIG. 3, all or part of the stinger 100 or conveyor belt 41 of each material dispenser 30 may be enclosed with an air restriction cover (not shown), similarly as described above with respect to covers 50, 60, 80.

In various embodiments, the system 10 may include one or more components that are internal to the material dispenser 30 for preventing the discharge of dust into the ambient air 12. In the embodiment of FIG. 1, at least a second vacuum-pressurized airflow duct 92 is disposed within each material dispenser 30 and fluidly coupled between at least one material storage compartment 37 and the central vacuum unit 14. The duct 92 may have any suitable configuration, form, components and operation. In this embodiment, the duct 92 is arranged and configured to draw in and capture dust created when material 32 is loaded into the material storage compartment 37, such as via one or more register 96, and direct it to the central vacuum unit 14.

If desired, the duct 92 may fluidly communicate with multiple material storage compartments 37 in the dispenser 30. For example, the duct 92 may extend at least substantially through the length of the material dispenser 30 above or over each of multiple storage compartments 37 therein (near the top 34 (FIG. 2) of the dispenser 30). If desired, the duct 92 may be specifically sized to provide the desired air velocity and/or volume through the dispenser 30. For example, the duct 92 may include multiple duct sections having successively increasing-sized internal diameters extending from the front end 38 to the rear end 40 of the dispenser 30 to maintain a substantially constant air flow velocity through the length of the duct 92 in the dispenser 30.

When included, each duct 92 may be fluidly coupled to the central vacuum unit 14 in any suitable manner. For example, the duct 92 may be fluidly coupled to at least one vacuum-pressurized airflow duct 70. In the illustrated example, a connection hose 72 couples the duct 92 of each material dispenser 30 to one of the ducts 70.

Still referring to FIG. 1, if desired, at least one flow control valve 74 may be disposed in the system 10 at any desired location(s), such as to allow selective control of the air flow rate and/or volume through the system 10, or one or more portions thereof. For example, a valve 74 may be disposed between each, or either, airflow duct 70 and the central vacuum unit 14. In the illustrated embodiment, a valve 74 is disclosed at the junction of each duct 70 and the connection hose 72 extending to the central vacuum unit 14. For another example, a valve 74 may be disposed between each or either airflow duct 70 and the duct 92 of each material dispenser 30. In this embodiment, a valve 74 is shown at the junction of each duct 70 and the connection hose 72 extending to each duct 92. The flow control valve 74 may have any suitable form, configuration and operation. For example, the valve 74 may be a conventional sliding gate valve.

An example operation of the dust containment system 10 of FIGS. 1-3 will now be described. Once the central vacuum unit 12, material dispenser(s) 30, material transfer unit(s) 22 and material receiving unit(s) 26 are positioned as desired relative to one another, some or all of the covers 50, 60, 80 are connected or positioned in the system 10 as needed. In this embodiment, the sheaths 52 are connected between the end 102 of each stinger 100 and over the corresponding access opening 24 of the dual-belt device 236. The exemplary sheath 62 is secured around the end of the delivery chute 240 of the dual-belt device 236 and over the bin 210 of the blender unit 224. The illustrated curtains 82 are dropped or positioned (and may be secured) along each side and each end of the dual-belt device 236. Each exemplary sheath 88 is positioned adjacent to part of the vertical portion 248 of the dual-belt device 236, as desired.

In this embodiment, connection hoses 72 are attached between adjacent components to create vacuum pressurization through the system 10. For example, connection hoses 72 may be connected between the duct(s) 70 and the central vacuum unit 12, between each duct 70 and the duct 92 of each adjacent dispenser 30, and between each duct 70 and one or more cover 50, 60, 80. In the embodiment of FIG. 2, connection hoses 76 are shown engaged between the duct 70 (nearest to side 242 of the dual-belt device 236) and the plates 86. For another example, a connection hose 78 is shown extending between the same duct 70 and the sheath 88 (FIG. 3). For yet another example, a connection hose 94 is shown extending between the other illustrated duct 70 and the sheath 62 (FIG. 3). The central vacuum system 10 is activated to pull air through the system 10, collecting dust dispersed when material 32 is loaded into the material dispenser(s) 30 and transferred to the material transfer unit 22 and material receiving unit 26.

The dust containment system 10 of the present disclosed may be used with apparatus, systems and methods disclosed in U.S. patent application Ser. No. 13/568,468 filed on Aug. 7, 2012 and entitled “APPARATUS AND METHODS FOR ASSISTING IN CONTROLLING THE DISCHARGE OF MATERIAL ONTO A CONVEYOR FROM A DISPENSER”, U.S. patent application Ser. No. 13/740,835 filed Jan. 14, 2013, entitled “APPARATUS AND METHODS FOR ASSISTING IN CONTROLLING MATERIAL DELIVERED ON A CONVEYOR”, and U.S. patent application Ser. No. 14/039,908 filed Sep. 27, 2013 and entitled “APPARATUS AND METHODS FOR MEASURING AND/OR ADJUSTING THE HEIGHT OF MATERIAL IN THE BIN OF A HOPPER ASSEMBLY”, all of which have a common assignee as the present application and each of which is incorporated by reference herein in its entirety.

Preferred embodiments of the present disclosure thus offer advantages over the prior art and are well adapted to carry out one or more of the objects of this disclosure. However, the present invention does not require each of the components and acts described above and is in no way limited to the above-described embodiments or methods of operation. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

1. System for containing airborne dust created during the transfer of material between components of a material delivery system with the use of at least one central vacuum unit that provides vacuum suction pressure to the system, the material delivery system including at least one material dispenser, at least one material transfer unit and at least one material receiving unit, the material dispenser having at least one material storage compartment compartment and at least one material discharge point, the material transfer unit having at least one material conveyor and the material receiving unit having at least one material receiving point, wherein material is loaded into the material storage compartment of the material dispenser and thereafter discharged from the material dispenser at the discharge point onto the conveyor of the material transfer unit and therefrom to the material receiving point of the material receiving unit, the system comprising:
a first air restriction cover at least partially encapsulating each material discharge point sufficient to contain airborne dust created when material is discharged to the material transfer unit at the discharge point and prevent such dust from escaping into the ambient air;
a second air restriction cover at least partially encapsulating each material receiving point sufficient to contain airborne dust created when material is received at the material receiving point from the material transfer unit and prevent such dust from escaping into the ambient air;
at least a first airflow duct mounted upon the material transfer unit, said first airflow duct being fluidly coupled to said air restriction covers and at least one central vacuum unit and configured to draw in air and dust contained in said first and second air restriction covers and direct it to the central vacuum unit: and
at least a second airflow duct disposed within the material dispenser, said second airflow duct being fluidly coupled to at least one material storage compartment therein and at least one central vacuum unit and configured to draw in airborne dust created in the material storage compartment when material is loaded therein and direct it to the central vacuum unit.

2. The system of claim l further including at least one flow control valve disposed between said first airflow duct and the central vacuum unit, said flow control valve being configured to selectively vary the flow of air through said first airflow duct.

3. The system of claim 1 wherein the material dispenser includes a plurality of material storage compartments, wherein said second airflow duct is disposed proximate to the top of the material dispenser over each storage compartment therein and fluidly connects all of the material storage compartments to the central vacuum unit.

4. The system of claim 3 wherein said second airflow duct is fluidly coupled to said first airflow duct, further including at least one flow control valve disposed between said first and second airflow ducts, said flow control valve being configured to selectively vary the flow of air through said second airflow duct.

5. The system of claim 3 wherein said second airflow duct has an elongated, tubular shape and is formed with multiple different internal diameters across its length.

6. The system of claim 3 further including a plurality of material dispensers all configured to concurrently dispense material to the material transfer unit, wherein said second airflow duct of each material dispenser is fluidly coupled to at least one said first airflow duct.

7. The system of claim 6 wherein said first airflow duct includes a pair of first airflow ducts mounted upon the material transfer unit, wherein said second airflow duct of some of the material dispensers is fluidly coupled to one of said first airflow ducts and said second airflow duct of the other material dispensers is fluidly coupled to the other of said first airflow ducts.

8. The system of claim 6 further including at least one flow control valve disposed between said second airflow duct and said first airflow duct, said flow control valve being configured to selectively vary the flow of air through said second airflow duct.

9. The system of claim 1 wherein the material is proppant, the material dispenser is a mobile hydraulic fracturing sand unit, the material transfer unit is a mobile dual-belt device and the material receiver is a mobile frac blender.

10. The system of claim I further including at least a third air restriction cover mounted upon the material transfer unit, said third air restriction cover at least substantially surrounding the at least one material conveyor of the material transfer unit and fluidly coupled to said first airflow duet, further including at least one air inlet opening associated with said third air restriction cover, said at least one air inlet opening allowing ambient air to flow into said air restriction cover and thereafter to said first airflow duct.

11. The system of claim 10 wherein said third air restriction cover is configured to prevent wind from creating dust in its proximity.

12. The system of claim 10 wherein said third air restriction cover includes at least one curtain configured to be positioned along at least one side of the material transfer unit.

13. The system of claim 10 wherein said third air restriction cover includes at least one lid configured to be positioned over at least a portion of the top of the material transfer unit and over the material conveyor therein.

14. The system of claim 10 wherein the material transfer unit includes at least one vertical portion, further wherein said third air restriction cover includes at least one sheath configured to be positioned adjacent to the vertical portion of the material transfer unit.

15. The system of claim 1 wherein said first air restriction cover is configured to prevent wind from creating dust at the adjacent corresponding material discharge point and said second air restriction cover is configured to prevent wind from creating dust at the adjacent corresponding material receiving point.

16. System for containing airborne dust created during the transfer of proppant between a hydraulic fracturing sand-conveying unit, dual-belt device and frac blender with the use of at least one central vacuum unit that provides vacuum suction pressure to the system, the sand-conveying unit having multiple material storage compartments and the dual-belt device having at least one material conveyor, wherein proppant is loaded into the material storage compartments of the sand-conveying unit and thereafter discharged from the sand-conveying unit onto the conveyor of the dual-belt device and therefrom to the frac blender, the system comprising:
at least a first airflow duct mounted upon the dual-belt device, said first airflow duct being fluidly coupled to at least one central vacuum unit; and
at least a second airflow duct disposed within and extending at least partially through the length of the sand-conveying unit, said second airflow duct being fluidly coupled to each material storage compartment therein and said first airflow duct and configured to draw in airborne dust created in the material storage compartments when proppant is loaded therein and direct it to said first air flow duct and ultimately to the central vacuum unit, said second airflow duct being configured so that air velocities remain substantially constant throughout the length thereof during use of the system.

17. The system of claim 16 wherein the sand-conveying unit includes a plurality of material storage compartments, wherein said second airflow duct is disposed proximate to the top of the sand-conveying unit over each storage compartment therein and fluidly connects all of the material storage compartments to the central vacuum unit.

18. The system of claim 16 wherein said second airflow duct has an elongated, tubular shape and is formed with multiple different internal diameters across its length.

19. The system of claim 16 further including at least one air restriction cover mounted upon the dual-belt device, said air restriction cover at least substantially surrounding the at least one material conveyor of the dual-belt device and fluidly coupled to said first airflow duct.

20. The system of claim 19 wherein said third air restriction cover includes at least one among at least one curtain configured to be positioned along at least one side of the dual-belt device and at least one lid configured to be positioned over at least a portion of the top of the dual-belt device and over the material conveyor therein.
